(19) United States
(12) Patent Application Publication
(10) Pub. No.: US 2009/0276414 A1
(43) Pub. Date: Nov. 5, 2009

(54) RANKING MODEL ADAPTATION FOR SEARCHING

(75) Inventors: Jianfeng Gao, Kirkland, WA (US); Qiang Wu, Bellevue, WA (US); Jiangyun Song, Bellevue, WA (US); Junyan Chen, Bellevue, WA (US); Steven Yao, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/112,826

(22) Filed: Apr. 30, 2008

(51) Int. Cl. G06F 17/30

(52) U.S. Cl. 707/5; 707/E17.014

(57) ABSTRACT

Search results provided by a search engine (e.g., for the Internet) are improved and/or made more accurate by addressing the limited availability of human labeled training data for certain domains (e.g., languages other than English, within certain date ranges, corresponding to queries over a certain length, etc.). More particularly, a ranking model trained on in-domain data, for which a small amount of human labeled training data (e.g., query/URL pairs) is available (e.g., languages other than English) is adjusted based upon out-domain data, for which a large amount of human labeled training data (e.g., query/URL pairs) is available (e.g., English). Thus, even though the resulting adapted in-domain ranking model is used in the context of in-domain data (e.g., non-English) to provide search results, the search results are improved because they are influenced by an abundance of, albeit out-domain, human labeled training data.

### BACKGROUND

The Internet has vast amounts of information distributed over a multitude of computers, thereby providing users with large amounts of information on varying topics. This is also true for a number of other communication networks, such as intranets and extranets. Finding information from such large amounts of data can be difficult.

Search engines have been developed to address the problem of finding information on a network. Users can enter one or more search terms into a search engine. The search engine will return a list of network locations (e.g., uniform resource locators (URLs)) that the search engine has determined contain relevant information. Often the development of a search engine (and search results provided thereby) relies heavily upon the availability of predefined human labeled training data. Human labeled training data generally refers to data collected from a group of relevancy experts who rank by hand the relevance of a number of query/URL pairs. Such data generally comprises a plurality of query/URL pairs ordered or otherwise arranged to provide an indication of just how relevant the URLs are to their corresponding queries (at least in the opinion of humans employed or otherwise engaged by a search engine entity to generate such data). Human labeled training data can be used for, among other things, training ranking models, relevance evaluations, and a variety of other search engine tasks. Ranking models, for example, facilitate ranking or prioritizing search results (e.g., so that more relevant results are presented first). It can be appreciated that the quality of ranking models depends to a large degree on the availability of large amounts of human labeled training data.

It can be appreciated that human labeling is an expensive and labor intensive task. Therefore, financial and logistical constraints only allow a small fraction of query/URL pairs to be labeled by humans. Furthermore, the majority of human labeling is performed on content (e.g., Web pages) written in English. Thus, the availability of human labeled training data for ranking models for languages other than English, for example, is extremely limited.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Search results provided by a search engine (e.g., for the Internet) are improved and/or made more accurate by addressing the limited availability of human labeled training data for certain domains (e.g., languages other than English, within certain date ranges, corresponding to queries over a certain length, etc.). More particularly, a ranking model trained on in-domain data, for which a small amount of human labeled training data (e.g., query/URL pairs) is available (e.g., languages other than English) is adjusted based upon out-domain data, for which a large amount of human labeled training data (e.g., query/URL pairs) is available (e.g., English). Essentially, one or more in-domain ranking models are trained with in-domain (e.g., non-English) training data and one or more out-domain ranking models are trained with out-domain (e.g., English) training data. Respective weighting factors are assigned to the trained in-domain and out-domain ranking models. Model adaptation (e.g., model interpolation) is then used to enhance the respective weighting factors for both the in-domain and out-domain models. This model adaptation, however, makes little to no use of out-domain (e.g., English) training data, but instead relies heavily on in-domain (e.g., non-English) training data. Moreover, the (in and/or out) domain training data used to enhance the weighting factors is different than the (in and/or out) domain training data used to train the in-domain and/or out-domain models. The in-domain and out-domain models are then combined to form an adapted in-domain ranking model. This adapted in-domain ranking model provides improved search results since the model is adapted based upon a greater amount of human labeled training data (e.g., out-domain data). That is, even though the adapted in-domain ranking model is used in the context of in-domain data (e.g., non-English) to provide search results, the search results are improved because they are influenced by the abundance of out-domain human labeled training data that is available from a different domain (e.g., English).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of improving search results by enhancing the relevance of ranking models.

FIG. 2 is a block diagram illustrating an exemplary implementation of a framework wherein search results are improved by enhancing the relevance of ranking models.

FIG. 3 is a block diagram illustrating a relationship between search query terms and features.

FIG. 4 is a table comprising a model for relevance ranking query/URL pairs trained with in-domain training data.

FIG. 5 is a table comprising a model for relevance ranking query/URL pairs trained with out-domain training data.

FIG. 6 is a table comprising an adapted in-domain ranking model based on the in-domain ranking model of FIG. 4 and the out-domain ranking model of FIG. 5, wherein enhancement is illustrated using an adaptation method and in-domain training data.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

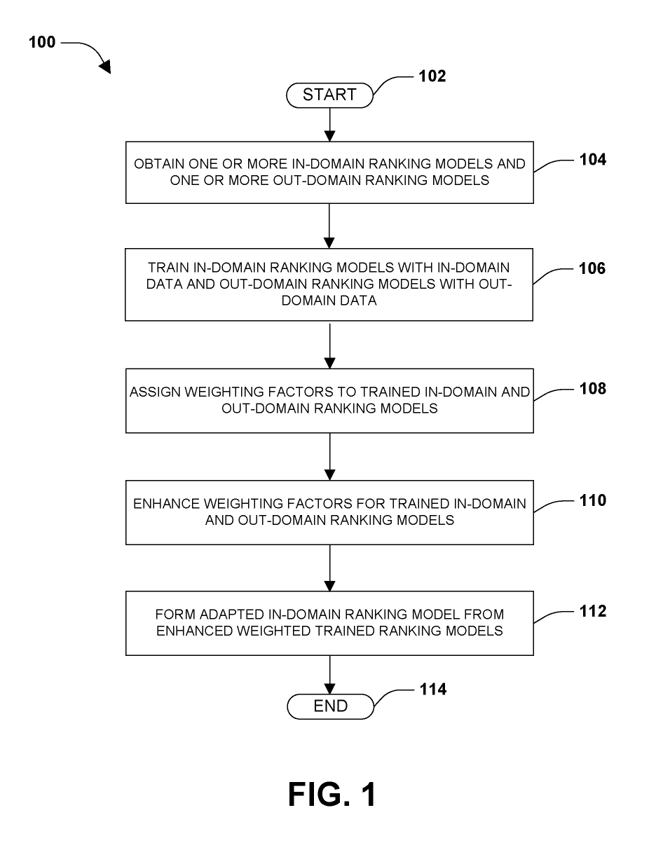

FIG. 1 illustrates an exemplary method 100 for enhancing search results by addressing the limited availability of human labeled training data for certain domains (e.g., languages other than English). More particularly, method 100 serves to improve a ranking model trained with in-domain data, for which a small amount of human labeled training data (e.g., 1 to 10 non-English query/URL pairs) is available, by adapting the model in view of out-domain data, for which a large amount of human labeled training data (e.g., 1000 to 1,000,000 English query/URL pairs) is available. It will be appreciated that while domains are often discussed in terms of languages herein (e.g., English vs. non-English), domains are not meant to be so limited. For example, domains can alternatively be based upon dates, query lengths, etc.

At 104 one or more in-domain ranking models and one or more out-domain ranking models are chosen or otherwise obtained. As will be discussed, the ranking models assist with ranking or prioritizing search results (e.g., so that more relevant results appear higher on a list). It will be appreciated that different types of ranking models exist, and any suitable model(s) may be chosen at 104. Also, the one or more in-domain and one or more out-domain ranking models may correspond to the same or different ranking models.

At 106 the one or more in-domain ranking models are trained using in-domain training data and the one or more out-domain ranking models are trained using out-domain training data. Training the ranking models generally comprises comparing an ordering or ranking of results (e.g., query/URL pairs) output by the models to an ordering or ranking of results (e.g., query/URL pairs) output or (pre)determined by human judges. As will be discussed in more detail below, the comparison utilizes a numerical formula (e.g., NDCG) to measure (e.g., determine a real number value) the difference between the ranking of results output by models and the ranking of results output by human judges. The ranking models are accordingly adjusted to enhance the agreement between the ranking of results output by models and the ranking of results output by human judges. It can be appreciated that a ranking model may be regarded as being of a higher quality when the ordering of the results output by the model matches or is close to the ordering of results determined by human judges.

Weighting factors are then assigned to the trained in-domain and trained out-domain ranking models at 108 to form one or more weighted trained in-domain ranking models and one or more weighted trained out-domain ranking models. In one embodiment weighting factors are vectors comprising multiple numerical values that generally correspond to how reliable a given model is (e.g., a weighting factor with larger values generally corresponds to a more reliable model than a weighting factor with smaller values). It will be appreciated that the weighting factors assigned to the trained in-domain and the trained out-domain ranking models may be the same or different.

At 110 the weighting factors for the one or more weighted trained in-domain ranking models and the weighting factors for the one or more weighted trained out-domain ranking models are enhanced using model adaptation to determine enhanced weighting factors. This enhancement operation generally utilizes in-domain training data that does not overlap (e.g., is different than) the in-domain training data used at 106 to train the in-domain ranking model. Model adaptation can comprise, for example, model interpolation to enhance the weighting factors. In one example, a neural network ranker is used to enhance the weighting factors as will be described more fully below. In alternative embodiments, also described more fully below, coordinate enhancement or the Powell method can be used. The enhancement at 110 produces one or more enhanced weighted trained in-domain ranking models and one or more enhanced weighted trained out-domain ranking models.

An adapted in-domain ranking model is then formed from the one or more enhanced weighted trained in-domain ranking models and the one or more enhanced weighted trained out-domain ranking models at 112. In one embodiment, the adapted in-domain ranking model is a linear combination of the one or more enhanced weighted trained in-domain ranking models and the one or more enhanced weighted trained out-domain ranking models. In alternative embodiments, the adapted in-domain ranking model forms other functional combinations of the one or more enhanced weighted trained in-domain ranking models and the one or more enhanced weighted trained out-domain ranking models. The adapted in-domain ranking model can then be used in the context of in-domain data to provide improved search results since an abundance of out-domain human labeled training data has been considered in developing the adapted in-domain ranking model.

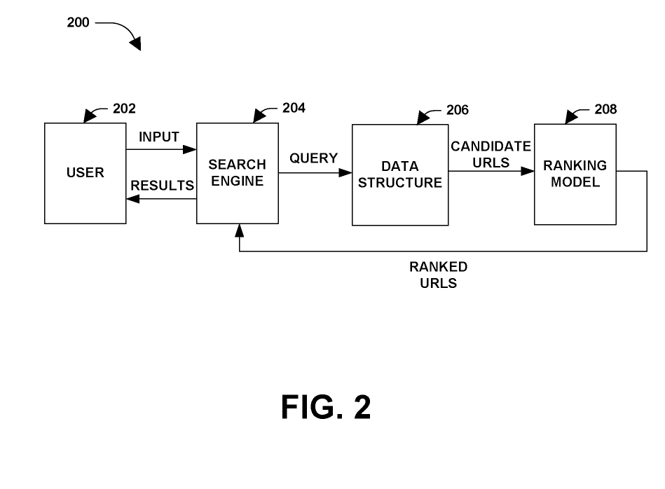

FIG. 2 is a block diagram illustrating an example of a suitable framework wherein search results can be improved by implementing an adapted in-domain ranking model to rank search results. A user 202 generates an in-domain query string which is entered into a search engine 204. The search engine 204 will access a data structure 206 (e.g., index) which stores a plurality of URLs. The search engine 204 will identify candidate URLs in the data structure 206 and send them to an adapted in-domain ranking model 208. The adapted in-domain ranking model 208 ranks the candidate URLs and returns ranked search results (query/URL pairs) to the search engine 204. The search engine 204 provides the ranked search results to the user 202. It will be appreciated that the adapted in-domain ranking model 208 is a function of an abundance of out-domain human labeled training data. Accordingly, regardless of the amount of in-domain human labeled training data available, the accuracy of the search is enhanced because more human labeled training data is consulted (e.g., in forming the adapted in-domain ranking model, of which the search results are a function), thus providing the user with more useful search results.

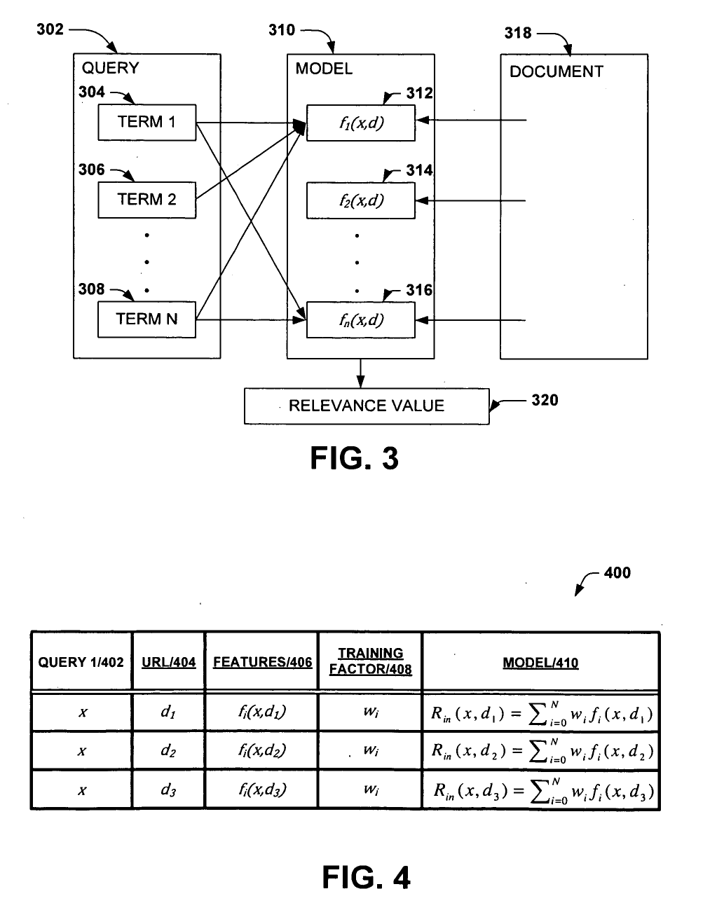

FIG. 3 is a block diagram illustrating the relationship between a search query 302, a ranking model 310, and a document containing relevant content 318 (e.g., a Web page corresponding to a particular URL). The search query 302 (e.g., the Cleveland Indians) comprises one or more query terms 304, 306, 308 (e.g., the, Cleveland, and Indians). The ranking model 310 comprises one or more feature functions 312, 314, 316, which may pertain, for example, to whether or not a query term is included in a Web page, the frequency of a query term in the Web page, the proximity of a query term to one or more other terms in the Web page, etc. To provide more relevant results, the one or more query terms 304, 306, 308 are associated with one or more feature functions 312, 314, 316 (e.g., the frequency of the term Cleveland in the Web page) of the ranking model 310. The one or more feature functions 312, 314, 316 of the model 310 will return a value based upon content of the document 318 relative to the search query 302 to provide a real number ( [symbol] ) relevance value 320 for a query/URL pair (x,dᵢ). For example, respective feature functions fᵢ(x,dᵢ) may map a vector comprising a query/URL pair (x,dᵢ) to a real value; fᵢ(x, dᵢ)→ [symbol] (e.g., as referenced below with regard to FIGS. 4-6).

FIG. 4 is an exemplary table 400 illustrating the different components of an in-domain ranking model (e.g., one of the models obtained at 104 in FIG. 1). Respective rows of table 400 comprise, among other things, a query 402 and a URL 404 which together form a query/URL pair (x, dᵢ) resulting from a given user search performed in the in-domain (e.g., in a language other than English). Note that respective rows of the table 400 comprise the same query x, but different URLs for that query (which is typical, as a single query routinely produces multiple URLs/results). A set of feature functions (fᵢ(x, dᵢ) 406 is associated with respective query/URL pairs (e.g., as described with regard to FIG. 3). In one embodiment, the feature functions 406 are pre-defined.

Furthermore, a separate training factor (wᵢ) 408 (e.g., a scalar value) is assigned to the feature functions 406, where the training factor takes into consideration the impact of human labeled in-domain training data during training. For example, during training a comparison utilizes a numerical formula (e.g., NDCG) to measure (e.g., determine a real number value) the difference between the ranking of results output by models (e.g., in-domain and out-domain ranking models) and the ranking of results output by human judges (e.g., human labeled training data). The values of the separate training factors (wᵢ) are adjusted to enhance the agreement (e.g., optimize the real number value) between the ranking of results output by models and the ranking of results output by human judges. In an example of a linear ranking model (e.g., in-domain model, out-domain model) where feature 1 is more important than feature 2, for example, a larger training factor value may be assigned to feature function 1 than feature function 2. For example, if a feature function corresponds to the number of times a term appears in a Web page, and this feature function is more important than another feature function, then a larger training factor would be assigned to this feature function (e.g., the number of times the word Indians appears in a Web page (feature 1) would be assigned a larger value than the proximity of the word Indians to the word Cleveland (feature 2)).

Referring again to FIG. 4, the in-domain ranking model 410 is a function of the feature functions 406 and training factors 408 associated with respective query/URL pairs. The in-domain model 410 calculates a first real number relevance score for respective query/URL pairs (x, dᵢ). The first real number relevance scores for the different query/URL pairs are used to rank the query/URL pairs (x, dᵢ) relative to one another (e.g., so that more relevant URLs may be listed before less relevant URLs). For the linear model illustrated in FIG. 4, the relevance score of a query/URL pair is calculated by summing the product of the training factors (wᵢ) 408 and the values returned from the associated feature functions (fᵢ(x, dᵢ) 406 as shown in the following equation:

$${R}_{i n} ( x , {d}_{i} ) = {\sum }_{i = 0}^{N} {w}_{i} {f}_{i} ( x , {d}_{i} )$$

where fᵢ(x, dᵢ) is the i^{th} feature function, wᵢ is the training factor associated with the i^{th} feature function, and N is the number of feature functions utilized in the ranking model Rᵢₙ(x, dᵢ).

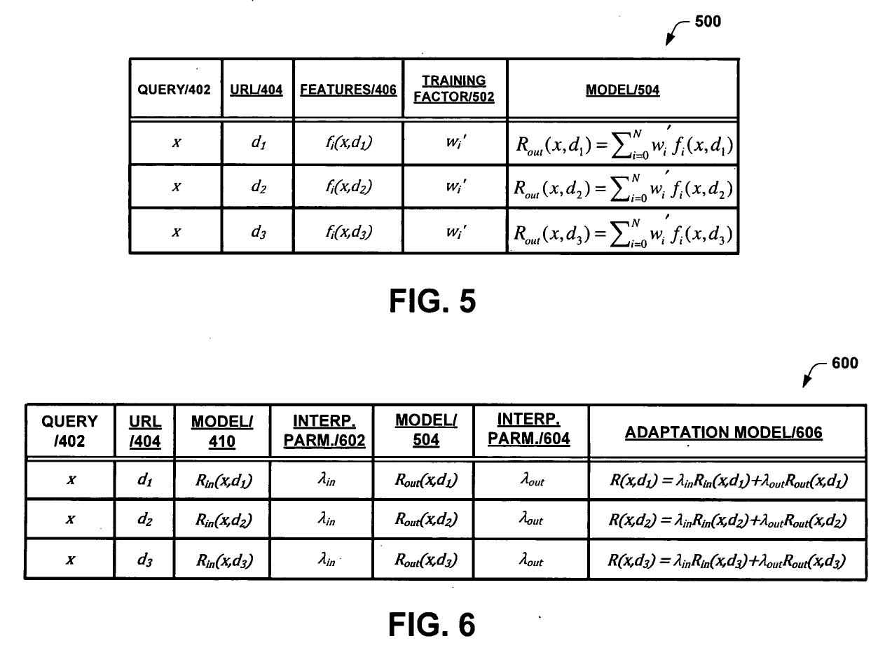

In FIG. 5, the different components of an out-domain ranking model (R_{out(x, d}ᵢ) are illustrated in exemplary table 500. FIG. 5 is similar to FIG. 4 except that different training factors (w′ᵢ) 502 are utilized that are based upon human labeled out-domain training data (whereas the training factors in FIG. 4 considered in-domain human labeled training data). The different training factors result in a second real number relevance score (e.g., possibly different than the first real number relevance score provided by the in-domain ranking model) that provides an alternative relevance score to rank the same query/URL pair (x, dᵢ) at least relative to the other query/URL pairs).

In FIG. 6, the components of an adapted in-domain ranking model formed from a linear combination of an enhanced weighted trained in-domain ranking model (e.g., FIG. 4) and an enhanced weighted trained out-domain ranking models (e.g., FIG. 5) are set forth in an exemplary table 600. Initially, a weighted trained in-domain ranking model is formed by assigning a weighting factor 602 (λᵢₙ) to the trained in-domain ranking model 410 (e.g., 108, FIG. 1). Similarly, a weighted trained out-domain ranking model is formed by assigning a weighting factor 604 (λₒᵤₜ) to the trained out-domain ranking model 504. Next, the respective weighted trained in-domain ranking model (Λᵢₙ(x, dᵢ) and weighted trained out-domain ranking model (Λ_{out R}ₒᵤₜ(x, dᵢ) are enhanced using model adaptation (e.g., model interpolation) with in-domain training data (e.g., 110, FIG. 1). Enhancing (e.g., optimizing) the weighting factors adjusts respective weighting factors for the different models based upon the level of agreement between search results output by the models and human labeled in-domain training data (e.g., human labeled search results). For example, a weighting factor for a model would be adjusted to bring search results output thereby in closer agreement with human labeled in-domain training data (e.g., relative to search results output by the model prior to the addition of the weighting factor). In another, more sophisticated, example, respective weighting factors are comprised within a matrix that is adjusted based upon agreement between model search results and human labeled in-domain training data. In one example, the in-domain training data used to enhance weighting factors λᵢₙ and λₒᵤₜ does not overlap the in-domain training data used to train the in-domain relevance model 410. Once the weighting factors λᵢₙ and λₒᵤₜ have been enhanced, the enhanced weighted trained in-domain ranking model and the enhanced weighted trained out-domain ranking model are combined to form an adapted in-domain ranking model 606. In the exemplary embodiment of FIG. 6, the adapted in-domain ranking model (R (x, dᵢ) is a linear combination of the enhanced weighted trained in-domain ranking model and the enhanced weighted trained out-domain ranking model according to the following equation:

R(x, d₁)≡ΛᵢₙRᵢₙ(x, dᵢ)+ΛₒᵤₜRₒᵤₜ(x, dᵢ)

In alternative embodiments, the adapted in-domain ranking model (R(x, dᵢ) forms other functional combinations of the one or more enhanced weighted trained in-domain ranking models and the one or more enhanced weighted trained out-domain ranking models. The adapted in-domain ranking model (R(x, dᵢ) provides a third real number relevance score to rank the same query/URL pair (x, dᵢ). The third real number relevance score provides a higher quality result for the in-domain query than would be possible based upon the small amount of in-domain training data since the abundance of out-domain training data has been considered.

Once the weighting factors are assigned, the one or more weighted trained in-domain ranking models and the one or more weighted trained out-domain ranking models require enhancement. The enhancement is performed by evaluating the final quality (e.g., agreement between the enhanced weighted trained ranking models and the in-domain training data) of the system according to the Normalized Discounted Cumulative Gain (NDCG). The NDCG of a ranking model provides a measure of ranking quality with respect to labeled training data. For a given query, the NDCG (Nᵢ) is computed as:

$${ℵ}_{i} = {N}_{i} {\sum }_{j = 1}^{L} \frac{{2}^{r ( j )} - 1}{log ( 1 + j )}$$

where r(j) is the relevance level of the j^{th} document, and where the normalization constant Nᵢ is chosen so that a desired (e.g., perfect) ordering would result in [symbol] =1. NDCG allows truncation of the number of documents (L) at which the NDCG ( [symbol] ) is computed (e.g., NDCG ( [symbol] ) can be computed for a given number (L) of query/URL pairs shown to a user). If truncation is used, the calculated NDCG ( [symbol] ) are averaged over the query set (e.g., number of query/URL pairs). Unfortunately, the NDCG ( [symbol] ) is difficult to enhance (e.g., optimize) since it is a non-smooth function. Therefore, three alternative model interpolation methods are set forth below for enhancing (e.g., optimizing) the weighting factors using in-domain training data: a neural network ranker, a method comprising a coordinate enhancement method, and method comprising the Powell algorithm. Any one of these three interpolation, or other, methods can be used to enhance (e.g., optimize) the weighting factors.

In one embodiment, a neural network ranker uses an implicit cost function (e.g., a decreasing function that provides a quality measure of a ranking model) whose gradients are specified by rules used to determine (e.g., optimize) the weighting factors. LambdaRank and LamdaSmart are two examples of neural network rankers that follow this concept. For example, in LambdaRank for a cost function C, the gradient of the cost function with respect to the score of the document at rank position j is chosen to be equal to a lambda function:

$$\frac{\partial C}{\partial {s}_{j}} = - {λ}_{j} ( {s}_{1} , {l}_{1} , … , {s}_{n} , {l}_{n} )$$

where sⱼ is the relevance score provided by the ranking model for the query/URL pair at rank position j and lⱼ is the label for the query/URL pair at rank position j. The sign preceding λⱼ is chosen so that a positive λⱼ value means that the query/URL pair must move up the ranked list to reduce the cost (it should be noted that λⱼ is a different variable than the weighting factors, λᵢₙ and λₒᵤₜ, referred to supra). A rule is defined relating the gradients of a first query/URL pair (associated with ranking index j₁) and a second query/URL pair (associated with rank index j₂). The rule specifies that rank index j₂ is greater than rank index j₁ (e.g., j₁ is ranked as more relevant than j₂), requiring that a preferred implicit cost function have the property that:

$$\vert \frac{\partial C}{\partial {s}_{j 1}} \vert ≫ \vert \frac{\partial C}{\partial {s}_{j 2}} \vert$$

where sⱼ₁ and sⱼ₂ are respectively the relevance scores of a first document (e.g., query/URL pair), with rank index j₁, and a second document (e.g., query/URL pair), with rank index j₂, that are being compared.

In practice, a cost function C that follows the specified rules is chosen and then the gradient of the cost function is taken to return a lambda value (λⱼ) specifying movement of the query/URL pairs within the ranking. In one specific embodiment, where a first query/URL pair (denoted in the following equation with subscript i) is to be ranked higher than a second query/URL pair (denoted in the following equation with subscript j), the Ranknet cost function can be used:

$${C}_{i , j}^{R} = {s}_{j} - {s}_{i} + log ( 1 + {e}^{{s}_{i} - {s}_{j}} )$$

where sᵢ and sⱼ are the scores of the first and second query/URL pair respectively. Taking the derivative of the cost function with respect to the score

$$( e . g . , \frac{\partial C}{\partial s} )$$

returns a lambda value (λⱼ). After the initial untrained (e.g., un-optimized) ranking, a document's position is incremented (e.g., moved up or down in the query/URL relevance ranking) by the resultant λⱼ value. As mentioned before, ranking resulting in a positive λⱼ value must move up the ranked list to reduce the cost.

In an alternative embodiment, model interpolation comprises using a coordinate enhancement algorithm to determine (e.g., optimize) the weighting factors. To utilize the coordinate enhancement algorithm the estimation problem is viewed as a multi-dimensional enhancement problem, with each model as one dimension. For example, using one in-domain and one out-domain model would result in a two dimensional enhancement problem. Coordinate enhancement takes a feature function, fᵢ(x, dᵢ), as a set of directions. The first direction is selected and the NDCG is maximized along that direction using a line search. A second direction is selected and the NDCG is maximized along the second direction using a line search. The coordinate enhancement method cycles through the whole set of directions as many times as is necessary, until the NDCG stops increasing.

In another alternative embodiment, model interpolation comprises using the Powell algorithm to determine (e.g., optimize) the weighting factors. The Powell algorithm also requires the estimation problem to be viewed as a multi-dimensional enhancement problem. The Powell method utilizes an initial set of directions Uᵢ are defined according to basis vectors (e.g., a set of vectors that, in a linear combination, can represent every direction in a given vector space). An initial guess x₀ of the location of the minimum of a function g(x) is made. A first extremum is found moving away from the initial guess x₀ along a direction Uᵢ. Once the first extremum is found, the Powell method moves along a second direction U_{N} until a second extremum is found. The method continues to switch directions and find minimums until a global extremum is found.

In one embodiment the Powell method will proceed through the following acts:
(i) Set P₀ equal to the starting position (e.g., set P₀=xᵢ).
(ii) For i=1:n, take steps away from the starting position P₀ along the direction uᵢ until a minimum is found, set the minimum equal to Pₖ; (e.g., find φ=φₖ that minimizes the function g(Pₖ₋₁+φUₙ) and set Pₖ=Pₖ₋₁+φUₙ).
(iii) Switch direction (e.g., set Uⱼ=Uⱼ₊₁ for j=1:n−1 and set Uₙ=Pₙ−P₀).
(iv) Increment the counter (e.g., i=i+1).
(v) Move away from Pₙ along the direction Uₙ until a minimum is found, set the minimum equal to P₀ (e.g., find the value of φ=φₘᵢₙ that minimizes the function g(P₀+φUₙ) and set xᵢ=P₀+φₘᵢₙUₙ).
(vi) Repeat (i) through (v) until convergence is achieved.
   In this manner, the Powell method constructs a set of N virtual directions that are independent of each other. A line search is used N times, each on one of the N virtual directions, to find the desired value. Variations on the Powell algorithm set forth above can also be used to enhance weighting factors for trained in-domain and out-domain ranking models.

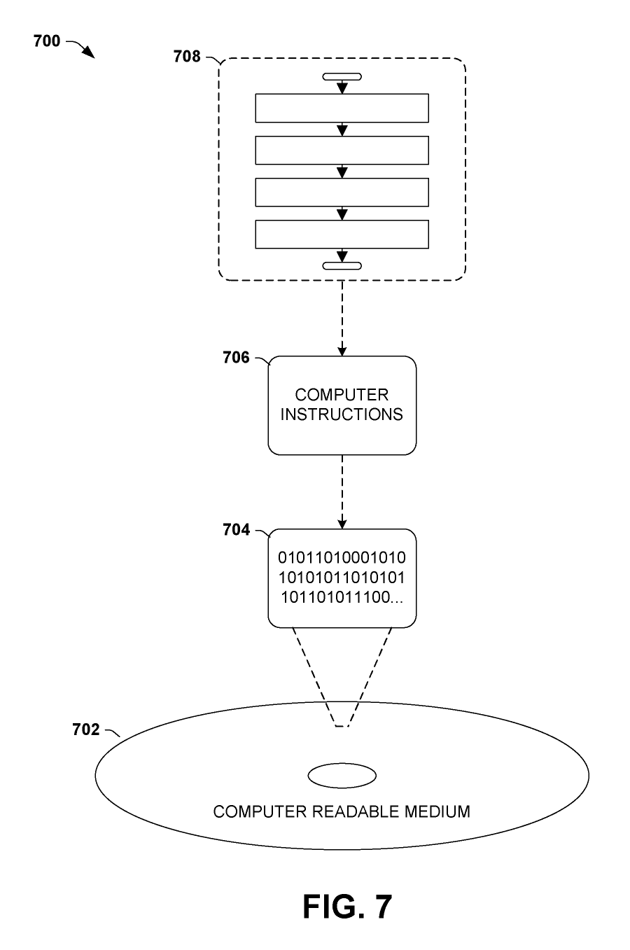

Still another embodiment involves a computer-readable medium comprising processor-executable instructions configured to apply one or more of the techniques presented herein. An exemplary computer-readable medium that may be devised in these ways is illustrated in FIG. 7, wherein the implementation 700 comprises a computer-readable medium 702 (e.g., a CD-R, DVD-R, or a platter of a hard disk drive), on which is encoded computer-readable data 704. This computer-readable data 704 in turn comprises a set of computer instructions 706 configured to operate according to one or more of the principles set forth herein. In one such embodiment, the processor-executable instructions 706 may be configured to perform a method of 708, such as the exemplary method 100 of FIG. 1, for example. In another such embodiment, the processor-executable instructions 706 may be configured to implement a system configured to improve the relevance rank of Web searches for a query. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

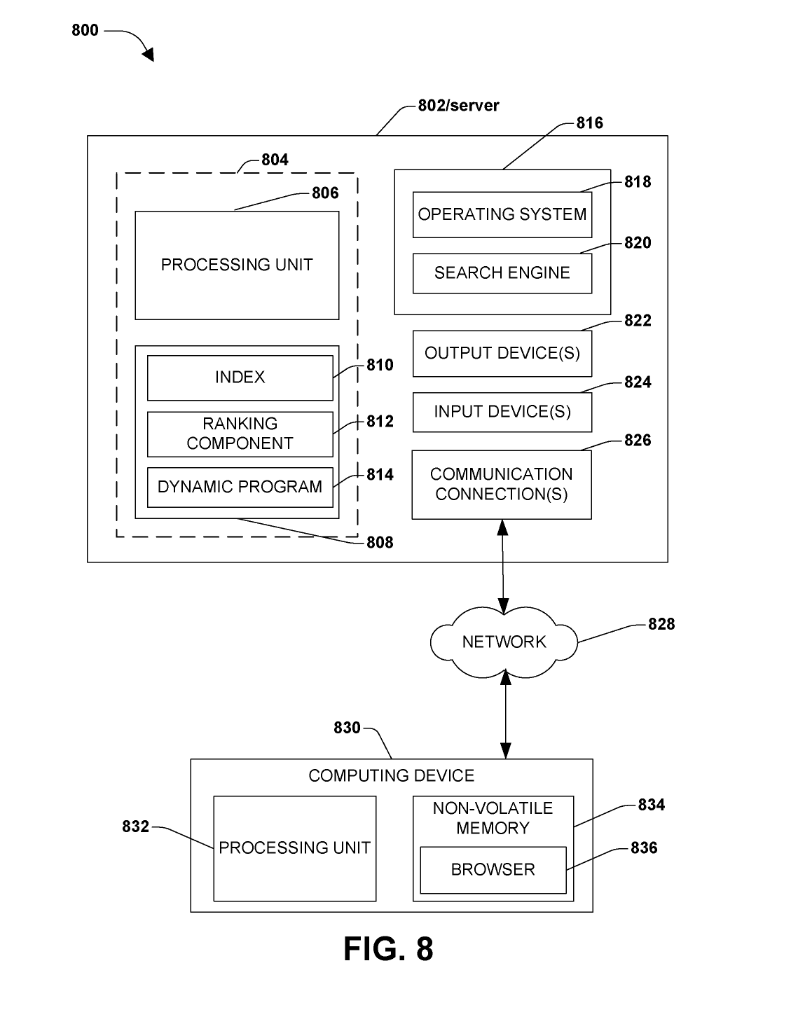

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 (e.g., server) configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. In the present invention, memory comprises an data structure index configured to store candidate URLs 810, an adapted in-domain ranking component 812, and a dynamic program or other processing component 814 configured operate the adapted in-domain ranking model on candidate URLs from the index. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 816. In one embodiment, computer readable instructions to implement one or more embodiments provided herein may be in storage 816. For example, the storage may comprise an operating system 818 and a search engine 820 in relation to one or more of the embodiments herein. Storage 816 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 816 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 820 that allows device 802 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 802. Input device(s) 824 and output device(s) 822 may be connected to device 802 via a wired connection, wireless connection, or any combination thereof. In one embodiment, an input device or an output device from another computing device may be used as input device(s) 824 or output device(s) 822 for computing device 802.

Components of computing device 802 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. In one configuration, computing device 830 includes at least one processing unit 832 and memory 834. Depending on the exact configuration and type of computing device, memory 808 may be volatile (such as RAM, for example), non-volatile (such as ROM, flash memory, etc., for example) or some combination of the two. In one embodiment, computer readable instructions to implement one or more embodiments provided herein may be in memory 834. For example, the memory may comprise a browser 836 in relation to one or more of the embodiments herein.

Computing device 802 may access computing device 830 and download a part or all of the computer readable instructions for execution. Alternatively, computing device 802 may download pieces of the computer readable instructions, as needed, or some instructions may be executed at computing device 802 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for adapting a ranking model, comprising:
obtaining one or more in-domain ranking models comprising a plurality of feature functions which map a query/URL pair to a first real number relevance score;
obtaining one or more out-domain ranking models comprising a plurality of feature functions which map the query/URL pair to a second real number relevance score;
training the in-domain ranking models and the out-domain ranking models;
assigning respective weighting factors to trained in-domain ranking models and trained out-domain ranking models;
enhancing the weighting factors using in-domain data according to an adaptation method; and
combining the enhanced weighted trained in-domain ranking models and the enhanced weighted trained out-domain ranking models to form an adapted in-domain ranking model which maps the query/URL pair to a third real number relevance score.

2. The method of claim 1, training the in-domain ranking models comprising using in-domain training data and training the out-domain ranking models comprising using out-domain training data.

3. The method of claim 2, the adaptation method comprising model interpolation.

4. The method of claim 3, the adapted in-domain ranking model comprising a linear combination of the enhanced weighted trained in-domain ranking models and the enhanced weighted trained out-domain ranking models.

5. The method of claim 4, the in-domain training data used to train the in-domain ranking model not overlapping the in-domain data used for enhancing the weighting factors using in-domain data according to an adaptation method.

6. The method of claim 5, the model interpolation comprising a neural network ranker using an implicit cost function whose gradients are specified by rules.

7. The method of claim 5, the model interpolation comprising a coordinate enhancement method.

8. The method of claim 5, the model interpolation utilizing the Powell algorithm.

9. The method of claim 5, the in-domain ranking models comprising a first language and the out-domain ranking models comprising one or more languages different than the first language.

10. A system configured to improve a relevance of Web searches for a query comprising:
a data structure configured to store a plurality of URLs;
an adapted in-domain ranking component configured to rank a plurality of query/URL pairs returned in response to the query, the adapted in-domain ranking component comprising a combination of one or more enhanced weighted trained in-domain ranking models and one or more enhanced weighted trained out-domain ranking models; and
a processing component configured to operate the adapted in-domain ranking model on candidate URLs from the data structure.

11. The system of claim 10, the adapted in-domain ranking model comprising respective weighting factors assigned to the enhanced weighted trained in-domain and enhanced weighted trained out-domain ranking models.

12. The system of claim 11, the enhanced weighted trained in-domain ranking models trained using in-domain training data and the enhanced weighted trained out-domain ranking models trained using out-domain training data.

13. The system of claim 12, the respective weighting factors enhanced using model interpolation using in-domain data.

14. The system of claim 13, the in-domain training data used to train the in-domain ranking model not overlapping the in-domain data used for enhancing the weighting factors.

15. The system of claim 14, the model interpolation comprising a neural network ranker using an implicit cost function whose gradients are specified by rules.

16. The system of claim 14, the model interpolation comprising a coordinate enhancement method.

17. The system of claim 14, the model interpolation utilizing the Powell algorithm.

18. The system of claim 14, the adapted in-domain ranking model comprising a linear combination of the enhanced weighted trained in-domain ranking models and the enhanced weighted trained out-domain ranking models.

19. The system of claim 14, the data structure comprising an index.

20. A method for adapting a ranking model, comprising:
obtaining one or more in-domain ranking models comprising a plurality of feature functions which map a query/URL pair to a first real number relevance score;
forming one or more out-domain ranking models comprising a plurality of feature functions which map the query/URL pair to a second real number relevance score;
training the in-domain ranking models using in-domain training data and training the out-domain ranking models using out-domain training data;
assigning respective weighting factors to trained in-domain ranking models and trained out-domain ranking models;
enhancing the weighting factors using in-domain data according to an interpolation method comprising at least one of a neural network ranker, a coordinate enhancement method, and the Powell algorithm; and
combining the enhanced weighted trained in-domain ranking models and the enhanced weighted trained out-domain ranking models to form an adapted in-domain ranking model which maps the query/URL pair to a third real number relevance score.
